(19) United States
(12) Patent Application Publication
(10) Pub. No.: US 2020/0130412 A1
(43) Pub. Date: Apr. 30, 2020

(54) Bearing Axle With Straight Shell And Hollow Cross Section

(71) Applicants: Lin He, Beijing (CN); Dong Xie, Beijing (CN); Qingsheng Guan, Beijing (CN)

(72) Inventors: Lin He, Beijing (CN); Dong Xie, Beijing (CN); Qingsheng Guan, Beijing (CN)

(21) Appl. No.: 16/515,072

(22) Filed: Jul. 18, 2019

(30) Foreign Application Priority Data
Oct. 25, 2018 (CN) 201811248873.9

(51) Int. Cl. B60B 35/16; B60B 35/14; B60K 1/00; B60B 35/12; B60G 11/10; B60B 35/00; B60K 17/16

(52) U.S. Cl. CPC B60B 35/163; B60B 35/14; B60K 1/00; B60Y 2200/91; B60G 11/10; B60B 35/007; B60K 17/165; B60B 35/122

(57) ABSTRACT

A bearing axle with straight shell and hollow cross section, is characterized in that the horizontal cross section of the axle housing is hollow, space of which is laid out an electric motor, a gearshift, a final drive and a differential. The advantages of the invention are as follows: the electric motor, final drive and differential integrated on the electric drive axle are fixed on the chassis to reduce the unsprung mass. The height of the motor is increased to change its adverse operation circumstances and the electric motor is not easy to be demagnetized. If the transmission is used, the gearshift on the spring is smoother than the gearshift under the spring.

### FIELD OF THE INVENTION

The invention relates to a driving axle in the field of electric vehicle, particularly to an electric vehicle drive system, a transmission system and a rear axle system.

### BACKGROUND OF THE INVENTION

Currently, the rear driving axle of battery electric vehicles is from modification based on the conventional rear axle. Some original equipment manufacturers use the electric driving axle integrated electric motor and conventional drive axle without the central driving shaft. The electric motor, final drive and differential are integrated into an assembled unit. The differential is used to the driving wheels through two driving shafts. The configuration is likely to conventional drive train structure, resulting in the increase of unsprung weight.

### SUMMARY OF THE INVENTION

With respect to the current electric drive axle structure, which integrates the electric motor, final drive and differential to result in the more than unsprung weight. If the gearshift mechanism is used in this configuration, the serious vibration of the axle may also bring out the gearbox failure, and this invention proposes a new type of electric vehicle axle structure.

The invention is realized in the following technology scheme:

An approach of bearing axle with straight shell and hollow cross section. Its features are as follows: the horizontal cross section of the axle is hollow or separated. This configuration leaves space to lay out the electric motor, final drive and differential which are integrated and fixed on the chassis. The axle housing forms a u-shaped groove profile, the height of vertical cross section of the axle is equal, and the upper end surface of the trumpet mouth structure is fixed with leaf spring to support the sprung mass.

The advantages of this invention are as follows:

The horizontal cross section of the vehicle axle is a hollow or separated structure. The electric motor, final drive and differential are integrated and fixed on the chassis. This structure overcomes the disadvantage of large unsprung mass of electric drive axle currently. If the transmission mechanism is used in this structure, the gearshift will be smoother than that the transmission is integrated into the driving axle. The layout is compact and reasonable, and the space utilization is improved.

### BRIEF DESCRIPTION OF THE DRAWINGS

FIG. 1 is an oblique view of bearing axle with straight shell and hollow cross section;

FIG. 2 is an oblique view of axle housing;

FIG. 3 is an oblique view of half shaft tube;

FIG. 4 is a cross-section view of half shaft tube;

FIG. 5 is an oblique view of assembly both axle and chassis;

FIG. 6 is a bottom view of assembly both axle and chassis;

FIG. 7 is an oblique view of a driving shaft.

### REFERENCE NUMERALS IN DRAWINGS

| | |
|---|---|
| 1 | leaf spring |
| 2 | wheel hub |
| 3 | electric motor carrier |
| 4 | axle housing |
| 5 | spring-seat |
| 6 | U-bolt |
| 7 | electric motor |
| 8 | final drive |
| 9 | chassis |
| 10 | driving shaft |
| 11 | outer shaft |
| 12 | outer cardan joint |
| 13 | middle shaft |
| 14 | inner cardan joint |
| 15 | inner shaft |
| 16 | flange |
| 17 | half shaft tube |
| 18 | shock absorber |
| 19 | differential |
| 20 | bearing |
| 21 | arc-shaped steel plate |
| 22 | reinforcing rib |

### DETAILED DESCRIPTION OF THE PREFERRED EMBODIMENTS

Referring to the figures.

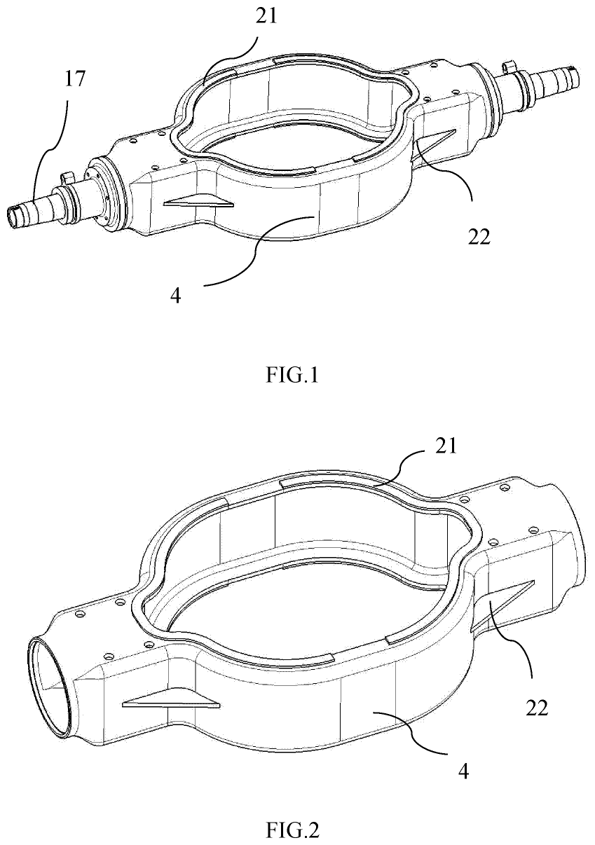

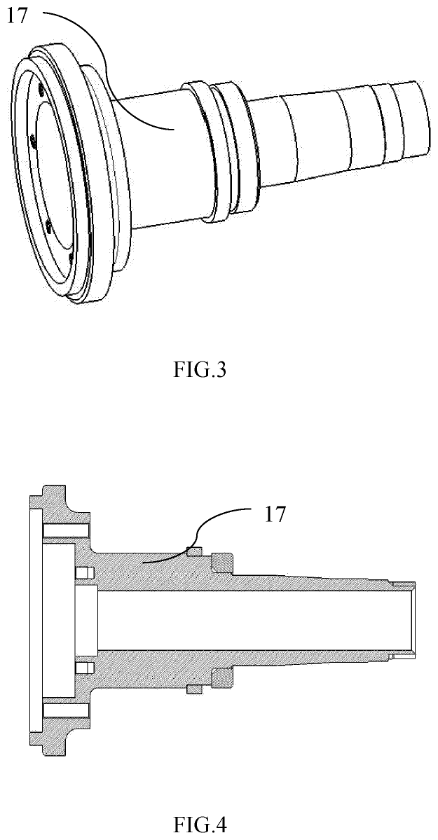

FIG. 1 is an oblique view of bearing axle with straight shell and hollow cross section. As can be seen from the FIG. 1, u-shaped shell construction is used in the middle of axle housing. The horizontal cross section of the axle housing is hollow, space of which is laid out an electric powertrain fixed on chassis. The electric powertrain is made up of an electric motor 7, a final drive 8, and a differential 19 etc. Height of vertical cross section of said axle housing is equal. The middle of the axle housing is straight. The left and right ends of two u-shaped shell construction are integrally connected to the trumpet mouth structure, the driving shaft 10 with cardan joints is disposed across the inner of the trumpet mouth structure. FIG. 7 is an oblique view of a driving shaft. In order to avoid collision between the driving shaft and axle housing when the driving shaft oscillates up and down, openings or protrusions can be made on the upper and lower surfaces of the trumpet mouth structure. The arc-shaped steel plates 21 are fixed at the opening on upper and lower surfaces of the axle housing through welding or screw-joints and other fastening methods. Front and back surfaces of the trumpet mouth structure at left and right ends of the axle housing can be welded with reinforcing ribs 22 respectively, increasing the overall strength.

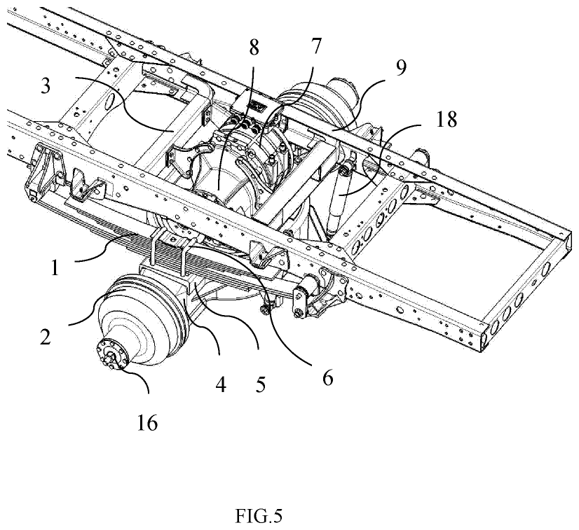

FIG. 3 is an oblique view of half shaft tube. FIG. 4 is a cross-section view of half shaft tube. The half shaft tube 17 and the flange are made one body. A step is made on the outer surface of the flange to fit the spatial demand of the brake backing plate. The height and thickness of the step fit the space demand of the arrangement of the brake backing plate. Half shaft tube 17 is internally provided with a bearing 20 which support the driving shaft 10.

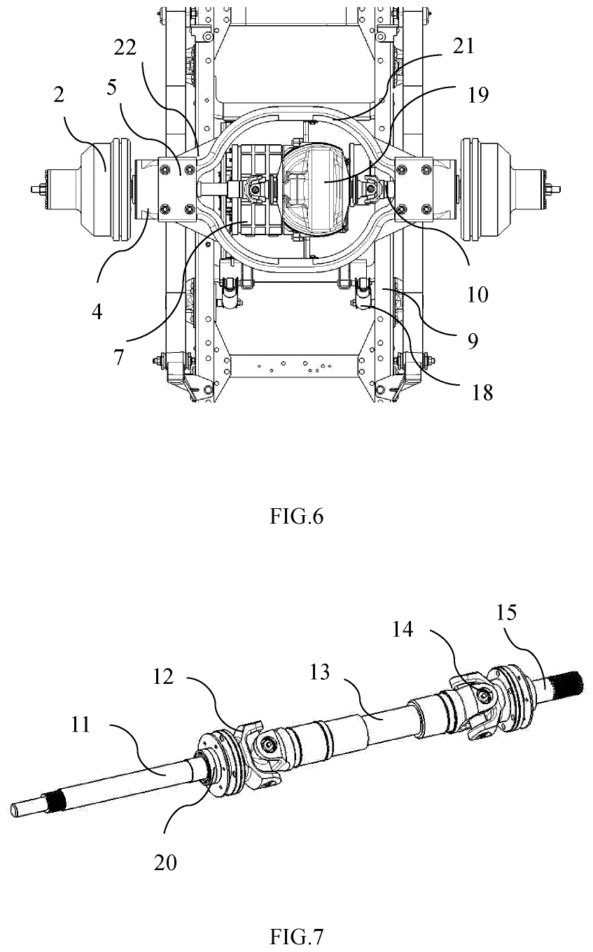

FIG. 5 is an oblique view of assembly both axle and chassis. FIG. 6 is a bottom view of assembly both axle and chassis. As can be seen in FIG. 4 and FIG. 5, the electric motor 7, final drive 8 and differential 19 are integrated and fixedly disposed on the chassis 9. The driving shaft that coupled with differential 19 are connected to wheel hub 2 across axle housing 4 and half shaft tube 17. The leaf spring 1 is put onto the upper end surface of axle housing 4, and support the sprung mass. The leaf spring 1 is fixedly disposed on the axle housing 4 with the U-bolt 6 and the spring seat 5.

1. A bearing axle with straight shell and hollow cross section consists of an axle housing, arc-shaped steel plates, half shaft tubes, and so on. Horizontal cross section of the axle housing is hollow, space of which is laid out an electric powertrain fixed on chassis. The electric powertrain is made up of an electric motor, a final drive, and a differential etc. The differential transmits power of electric motor to driving shafts. The driving shafts transmit the power to wheels, and then, vehicle is driven forward by wheels.

2. The bearing axle with straight shell and hollow cross section according to claim 1, is characterized in that said housing shows a kind of u-shaped shell construction, and the horizontal cross section of said axle is hollow.

3. The bearing axle with straight shell and hollow cross section according to claim 1, is characterized in that said axle is straight, and height of vertical cross section of said axle housing is equal.

4. The bearing axle with straight shell and hollow cross section according to claim 1, is characterized in that both ends of said axle are being trumpet mouth structure, which is used to fix leaf spring and hold cardan joint of the driving shaft.

5. The bearing axle with straight shell and hollow cross section according to claim 1, is characterized in that the arc-shaped steel plates are fixed on the upper and lower surfaces of the axle housing by means of welding or screw-joints and other fastening methods.

6. The bearing axle with straight shell and hollow cross section according to claim 1, is characterized in that the half shaft tube is welded together with the axle housing, and the half shaft tube is being a bearing hole to arrange the bearing which supports the driving shaft.

7. The bearing axle with straight shell and hollow cross section according to claim 1, is characterized in that in order to avoid collision and interference between the driving shaft and axle housing when the driving shaft oscillates up and down, openings or protrusions can be made on the upper and lower surfaces of both ends of trumpet mouth structure.

8. The bearing axle with straight shell and hollow cross section according to claim 1, is characterized in that a step is made on outer surface of the flange. The flange is integrally formed with the half shaft tube as one piece unit, so as to fit the spatial demand of the brake backing plate.

9. The bearing axle with straight shell and hollow cross section according to claim 1, is characterized in that the half shaft tube can be made long, the axle housing is relatively shortened, so that the cardan joint may be partly put into the inner of the half shaft tube.

10. The bearing axle with straight shell and hollow cross section according to claim 1, is characterized in that the front and back surfaces of the axle trumpet mouth structure at left and right ends of the axle housing, can be welded with reinforcing ribs respectively.
